(19) United States
(12) Patent Application Publication
(10) Pub. No.: US 2007/0103420 A1
(43) Pub. Date: May 10, 2007

(54) Driving circuit and driving method for active matrix liquid crystal display using optical sensor

(75) Inventors: Ti-Kai Chao, Miao-Li (TW); Cheng-Hsiu Lee, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/593,269

(22) Filed: Nov. 6, 2006

(30) Foreign Application Priority Data
Nov. 4, 2005 (TW) 94138776

(51) Int. Cl. G09G 3/36

(52) U.S. Cl. 345/98

(57) ABSTRACT

A driving circuit of an active matrix liquid crystal display (LCD) (600) having an LCD panel includes a plurality of gate lines (601) that are parallel to each other; a plurality of data lines (602) that are parallel to each other and across the gate lines; a gate driving circuit (610) connected to the gate lines; a data driving circuit (620) connected to the data lines; a timing control circuit (630) configured for driving the data driving circuit and the gate driving circuit; and an optical sensor (690) connected to the timing control circuit. The optical sensor generates a plurality of inspecting signals according to a flickering intensity of the LCD panel and provides the inspecting signals to the timing control circuit. The timing control circuit prepares a plurality of compensating gradation voltages according to the inspecting signals and providing the compensating gradation voltages to the data driving circuit.

### FIELD OF THE INVENTION

The present invention relates a driving circuit and an active matrix LCD using the same. The present invention also relates to a driving method of the active matrix LCD.

### GENERAL BACKGROUND

An active matrix LCD device has the advantages of portability, low power consumption, and low radiation, and has been widely used in various portable information products such as notebooks, personal digital assistants (PDAs), video cameras and the like. Furthermore, the active matrix LCD device is considered by many to have the potential to completely replace CRT (cathode ray tube) monitors and televisions.

FIG. 5 is essentially an abbreviated circuit diagram of a typical active matrix LCD. The active matrix LCD 100 includes an LCD panel 140, a data driving circuit 120, a gate driving circuit 110, and a timing control circuit 130. The LCD panel 140 includes a first substrate (not shown), a second substrate (not shown) arranged in a position facing the first substrate, and a liquid crystal layer (not shown) sandwiched between the first substrate and the second substrate. Liquid crystal material of the liquid crystal layer has anisotropic transmittance.

The first substrate includes a number n (where n is a natural number) of gate lines 101 that are parallel to each other and that each extend along a first direction, and a number m (where m is also a natural number) of data lines 102 that are parallel to each other and that each extend along a second direction orthogonal to the first direction. The intersecting gate lines 101 and data lines 102 define a plurality of pixel units therebetween. The first substrate also includes a plurality of thin film transistors (TFTs) 106 that function as switching elements. The first substrate further includes a plurality of pixel electrodes 103 formed on a surface thereof facing the second substrate. Each TFT 106 is provided in the vicinity of a respective point of intersection of the gate lines 101 and the data lines 102.

The second substrate includes a plurality of common electrodes 105 opposite to the pixel electrodes 103. In particular, the common electrodes 105 are formed on a surface of the second substrate facing the first substrate, and are made from a transparent material such as ITO (Indium-Tin Oxide) or the like.

FIG. 6 is an equivalent circuit diagram of one pixel unit of the active matrix LCD 100. A gate electrode “g”, a source electrode “s”, and a drain electrode “d” of a TFT 106 are connected to a gate line 101, a data line 102, and a pixel electrode 103 respectively. Liquid crystal material sandwiched between the pixel electrode 103 and a common electrode 105 on the second substrate (not shown) is represented as a liquid crystal capacitor C_{lc}. C_{gd} is a parasitic capacitor formed between the gate electrode “g” and the drain electrode “d” of the TFT 106.

When the active matrix LCD 100 works, an electric field between the pixel electrode 103 and the common electrode 105 is applied to the liquid crystal material of the liquid crystal layer. Light from a light source such as a backlight passes through the second substrate, the liquid crystal layer, and the first substrate. The amount of the light penetrating the substrates is adjusted by controlling the strength of the electric field, in order to obtain a desired optical output for the pixel unit.

If an electric field between the pixel electrode 103 and the common electrode 105 continues to be applied to the liquid crystal material in one direction, the liquid crystal material may deteriorate. Therefore, in order to avoid this problem, pixel voltages that are provided to the pixel electrode 103 are switched from a positive value to a negative value with respect to a common voltage. This technique is referred to as an inversion drive method.

FIG. 7 is an abbreviated timing chart illustrating operation of the active matrix LCD 100. In the chart, the x-axis represents time, and the y-axis (not shown) represents voltage. V_{g} represents a plurality of scanning signals provided by the gate driving circuit 110. V_{d} represents a plurality of gradation voltages provided by the data driving circuit 120. Vₚ represents a plurality of pixel voltages of the pixel electrode 103. ΔV_{g} represents the impulse width of each of the scanning signals V_{g}, and equals the difference between a gate-on signal Vₒₙ and a gate-off signal V_{off}. V_{com} represents a common voltage of the common electrode 105 provided by an external circuit (not shown). ΔV represents a voltage distortion related to the pixel voltage V_{d}.

When a gate-on voltage Vₒₙ is provided to the gate electrode “g” of the TFT 106 via the gate line 101, the TFT 106 connected to the scanning line 101 turns on. At the same time, a gradation voltage V_{d} generated by the data driving circuit 120 is provided to the pixel electrode 103 via the data line 102 and the activated TFT 106 in series. The potentials of the common electrodes 105 are set at a uniform potential V_{com}. Thus, an electric field is generated by the voltage difference between the pixel electrode 103 and the common electrode 105. The electric field is used to control the amount of light transmission of the corresponding pixel unit.

When a gate-off voltage V_{off} is provided to the gate electrode “g” of the TFT 106 via the gate line 101, the TFT 106 turns off. The gradation voltage V_{d} applied to the liquid crystal capacitor C_{lc} while the TFT 106 was turned on should be maintained after the TFT 106 turns off. However, due to the parasitic capacitance C_{gd} between the gate electrode “g” and the drain electrode “d” of the TFT 106, the gradation voltage V_{d} applied to the pixel electrode 103 is distorted. This kind of voltage distortion ΔV is known as a kick-back voltage, and the kick-back voltage is obtained by following formula:

$$Δ V = \frac{{C}_{gd}}{{C}_{gd} + {C}_{lc}} \times Δ {V}_{g} \qquad ( 1 )$$

The voltage distortion ΔV always tends to reduce the pixel voltage Vₚ regardless of the polarity of the data voltage, as shown in FIG. 7.

In an ideal active matrix LCD 100 as shown by a dotted line V_{d} in FIG. 7, when the gate-on voltage Vₒₙ is provided to turn on the TFT 106, the gradation voltage V_{d} is applied to the pixel electrode 103, and thereby, when the gate-off voltage V_{off} is provided to turn off the TFT 106, the applied gradation voltage V_{d} should be maintained as the pixel voltage. But in an actual active matrix LCD 100 as shown by a solid line Vₚ in FIG. 7, when the scanning signal V_{g} falls, the pixel voltage Vₚ is reduced by the kickback voltage ΔV.

An actual value of the voltage supplied to the liquid crystal material is obtained from the area between the pixel voltage Vₚ and the common voltage V_{com} lines in FIG. 7. In one time frame (“Frame”), the pixel voltage Vₚ is greater than the common voltage V_{com}, and this area can be considered to be a ‘positive’ area. In an adjacent frame, the pixel voltage Vₚ is less than the common voltage V_{com}, and this area can be considered to be a ‘negative’ area. When the active matrix LCD 100 is driven by an inversion drive method, the level of the common voltage V_{com} must be adjusted to keep the positive area of the one frame equal to the negative area of the adjacent frame. Therefore, a common voltage V_{com} satisfying the above-mentioned condition needs to be supplied to the common electrode 105 in order to suppress the so-called flicker phenomena of a display screen of the LCD panel 140.

Nevertheless, even when a constant common voltage that can make the above-noted areas equal is supplied to the common electrode 105, the flicker phenomena still may occur.

Generally, the gate lines 101 have both resistance and parasitic capacitance. Thus, the scanning signal V_{g} is delayed by a time constant, which is determined by the product of resistance and parasitic capacitance. As the size of the display screen of the LCD panel 140 becomes larger, the signal delay of the scanning signal V_{g} becomes correspondingly longer.

FIG. 8 is a graph of measured values of the scanning signal V_{g} at two different points along a length of the gate line 101. V_{g1} represents the scanning signal measured on a point of the gate line 101 that is near the gate driving circuit 110, and V_{g2} represents the scanning signal measured on another point of the same gate line 101 that is far from the gate driving circuit 110. As seen, the scanning signal V_{g2} is delayed compared to the scanning signal V_{g1}.

Hence, the further from the scanning signal input terminal (gate driving circuit 110), the smaller the impulse width ΔV_{g} of the scanning signal V_{g}. Thus the kickback voltage ΔV also decreases with such increasing distance, as indicated by equation (1).

Therefore even when a constant common voltage is used, this voltage cannot maintain the desired mid-voltage value for all the pixel units. Accordingly, pixel voltages may still vary from frame to frame, and the flicker phenomena may subsist. As the size of the display screen of the LCD panel 140 becomes larger, the gate lines 101 become correspondingly longer, and the flicker phenomena is correspondingly liable to occur more frequently.

FIG. 9 is essentially an abbreviated circuit diagram of another typical active matrix LCD. The active matrix LCD 500 includes an LCD panel 540, a data driving circuit 520, a gate driving circuit 510, and a common voltage generator 530. The LCD panel 540 includes a first substrate (not shown), a second substrate (not shown) arranged in a position facing the first substrate, and a liquid crystal layer (not shown) sandwiched between the first substrate and the second substrate.

The first substrate includes a number n (where n is a natural number) of gate lines 501 that are parallel to each other and that each extend along a first direction, and a number m (where m is also a natural number) of data lines 502 that are parallel to each other and that each extend along a second direction orthogonal to the first direction. The first substrate also includes a plurality of thin film transistors (TFTs) 506 that function as switching elements. The first substrate further includes a plurality of pixel electrodes 503 formed on a surface thereof facing the second substrate. Each TFT 506 is provided in the vicinity of a respective point of intersection of the gate lines 501 and the data lines 502.

The second substrate includes a plurality of common electrodes 505 opposite to the pixel electrodes 503. In particular, the common electrodes 505 are formed on a surface of the second substrate facing the first substrate.

The gate driving circuit 510 provides a plurality of scanning signals to the gate lines 501. The data driving circuit 520 provides a plurality of gradation voltages to the data lines 502 when the gate lines 501 are scanned.

The common voltage circuit 530 includes a power supply 539, a first variable resistor 531, and a second variable resistor 532. One terminal of the first variable resistor 531 is connected to ground. The other terminal of the first variable resistor 531 is connected to a first common point 534 that is physically close to an output of the gate driving circuit 510. One terminal of the second variable resistor 532 is connected to the power supply 539. The other terminal of the second variable resistor 532 is connected to the common electrode 505 at a second common point 533 that is physically farther from the output of the gate driving circuit 510 than the first common point 534. The common voltage circuit 530 provides a first common voltage and a second common voltage to the first common point 534 and the second common point 533, respectively. The first common voltage is lower than the second common voltage.

Because the active matrix LCD 500 includes a common voltage circuit 530, an operator can adjust the resistances of the first and second variable resistors 531, 532 to change the respective common voltages at the first and second common points 534, 533. Thus, the flicker phenomena caused by the various factors described above can be suppressed or even eliminated.

However, the operator needs to personally detect the flicker phenomena of the active matrix LCD 500, and then adjust the resistances of the first and second variable resistors 531, 532 according to the degree of flicker phenomena present as judged by the operator himself/herself. Thus, the adjusting procedure for suppressing the flicker phenomena is subject to human error.

What is needed, therefore, is an active matrix LCD that can overcome the above-described deficiencies.

### SUMMARY

In one preferred embodiment, a driving circuit of an active matrix LCD having an LCD panel includes a plurality of gate lines that are parallel to each other and that each extend along a first direction; a plurality of data lines that are parallel to each other and that each extend along a second direction substantially orthogonal to the first direction; a gate driving circuit connected to the gate lines; a data driving circuit connected to the data lines; a timing control circuit configured for driving the data driving circuit and the gate driving circuit; and an optical sensor connected to the timing control circuit via a conducting line. The optical sensor generates a plurality of inspecting signals according to a flickering intensity of the LCD panel and provides the inspecting signals to the timing control circuit. The timing control circuit prepares a plurality of compensating gradation voltages according to the inspecting signals and providing the compensating gradation voltages to the data driving circuit.

Other advantages and novel features will become more apparent from the following detailed description when taken in conjunction with the accompanying drawings.

### BRIEF DESCRIPTION OF THE DRAWINGS

FIG. 1 is essentially an abbreviated circuit diagram of an active matrix LCD according to a preferred embodiment of the present invention, the active matrix LCD including an LCD panel (having a display screen), an optical sensor, and a timing control circuit.

FIG. 2 is a graph of a voltage wave of inspecting signals generated by the optical sensor varying over time according to an intensity of flickering of the display screen of the LCD panel of FIG. 1.

FIG. 3 is a diagram of voltage waves including compensating gradation voltages generated by the timing control circuit of the active matrix LCD of FIG. 1.

FIG. 4 is a block diagram of certain parts of the active matrix LCD of FIG. 1, schematically showing steps in an exemplary driving method of the active matrix LCD.

FIG. 5 is essentially an abbreviated circuit diagram of a conventional active matrix LCD, the active matrix LCD including a plurality of gate lines and a plurality of pixel units.

FIG. 6 is an equivalent circuit diagram of one pixel unit of the active matrix LCD of FIG. 5.

FIG. 7 is an abbreviated timing chart illustrating operation of the active matrix LCD of FIG. 5.

FIG. 8 is a graph of measured values of a scanning signal at two different points along a length of one of the gate lines of the active matrix LCD of FIG. 5.

FIG. 9 is essentially an abbreviated circuit diagram of another conventional active matrix LCD.

### DETAILED DESCRIPTION OF PREFERRED EMBODIMENTS

FIG. 1 is essentially an abbreviated circuit diagram of an active matrix LCD according to a preferred embodiment of the present invention. The active matrix LCD 600 includes an LCD panel 640, a data driving circuit 610, a gate driving circuit 620, a timing control circuit 630, and an optical sensor 690. The display panel 640 includes a first substrate (not shown), a second substrate (not shown) arranged in a position facing the first substrate, and a liquid crystal layer (not shown) sandwiched between the first substrate and the second substrate. The timing control circuit 630 includes a memory unit 632.

The first substrate includes a number n (where n is a natural number) of gate lines 601 that are parallel to each other and that each extend along a first direction, and a number m (where m is also a natural number) of data lines 602 that are parallel to each other and that each extend along a second direction orthogonal to the first direction. The first substrate also includes a plurality of thin film transistors (TFTs) 606 that function as switching elements. The first substrate further includes a plurality of pixel electrodes 603 formed on a surface thereof facing the second substrate. Each TFT 606 is provided in the vicinity of a respective point of intersection of the gate lines 601 and the data lines 602.

The second substrate includes a plurality of common electrodes 605 opposite to the pixel electrodes 603. In particular, the common electrodes 605 are formed on a surface of the second substrate facing the first substrate, and are made from a transparent material such as ITO (Indium-Tin Oxide) or the like.

The gate driving circuit 610 provides a plurality of scanning signals to the gate lines 601. The data driving circuit 620 provides a plurality of gradation voltages to the data lines 602 when the gate lines 601 are scanned.

The optical sensor 690 is positioned between the first substrate and the second substrate. A conducting line 691 formed on the first substrate interconnects the optical sensor 690 and the timing control circuit 630. The optical sensor 690 generates a plurality of inspecting signals according to an intensity of flickering of a display screen (not shown) of the LCD panel 640, and provides the inspecting signals to the timing control circuit 630 via the conducting line 691.

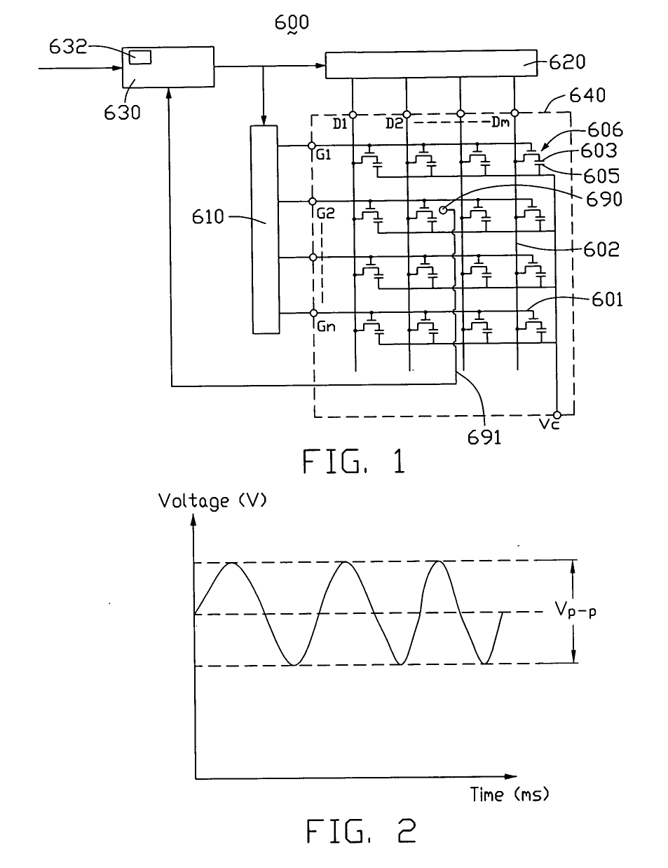

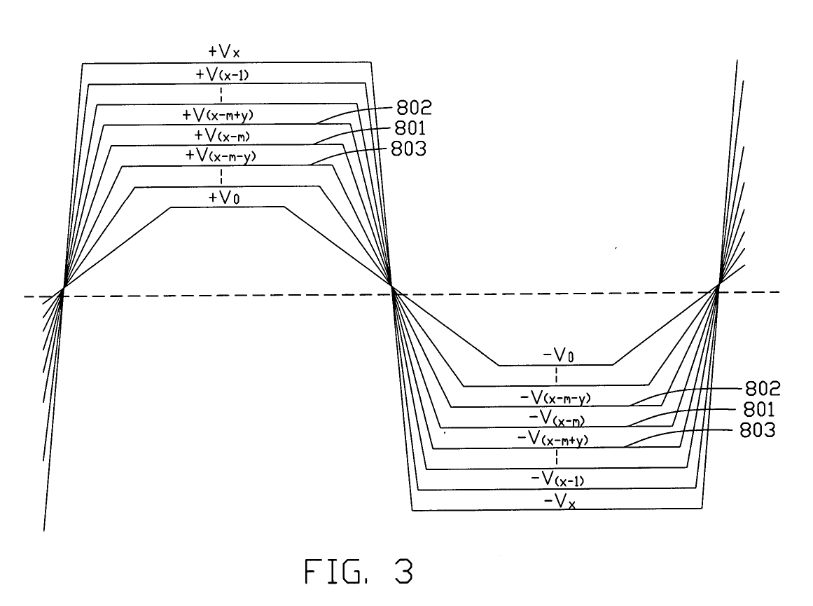

FIG. 2 is a graph of a voltage wave of inspecting signals generated by the optical sensor 690 according to a flickering intensity of the display screen of the LCD panel 640. Vp-p represents a pulse width of the inspecting signals. A value of Vp-p varies in direct proportion to the flickering intensity of the display screen of the LCD panel 640.

The timing control circuit 630 generates a plurality of compensating gradation voltages for suppressing or eliminating the flicker of the display screen of the LCD panel 640, according to the inspecting signals received. According to each inspecting signal, the timing control circuit 630 generates a pair of compensating gradation voltages that has the best effect for suppressing or eliminating the flicker of the display screen of the LCD panel 640. Then the timing control circuit 630 loads the pair of compensating gradation voltages and the corresponding inspecting signal to the memory unit 632. In the preferred embodiment, the memory unit 632 includes a look-up table storing a relationship between the inspecting signal and a pair of compensating gradation voltages that have the best effect for suppressing or eliminating the flicker of the display screen of the LCD panel 640. Data in the look-up table is built up over time, with new compensating gradation voltages being stored in the look-up table each time a corresponding new inspecting signal is processed by the timing control circuit 630.

In a further or alternative embodiment, the timing control circuit 630 can directly send the generated compensating gradation voltages to the data driving circuit 620 without the compensating gradation voltages ever being sent to and stored in the look-up table.

In a still further alternative embodiment, the look-up table may be completely set up with comprehensive inspecting signal data and corresponding compensating gradation voltages before the LCD 600 is used for the first time. In such case, the timing control circuit 630 can read the compensating gradation voltages in the look-up table that correspond to a received inspecting signal, obtain these compensating gradation voltages from the look-up table, and send the compensating gradation voltages to the data driving circuit 620, without ever generating new compensating gradation voltages.

In a yet further alternative embodiment, each time the timing control circuit 630 receives an inspecting signal, the timing control circuit 630 can first check the look-up table to determine whether the look-up table already has compensating gradation voltages corresponding to the received inspecting signal. If the look-up table has the corresponding compensating gradation voltages, the timing control circuit 630 obtains these compensating gradation voltages from the look-up table, and sends the compensating gradation voltages to the data driving circuit 620. If the look-up table does not have any corresponding compensating gradation voltages, the timing control circuit 630 then generates new compensating gradation voltages corresponding to the received inspecting signal, loads the new compensating gradation voltages and the inspecting signal to the look-up table, and sends the new compensating gradation voltages to the data driving circuit 620. Alternatively, the timing control circuit 630 can send the new compensating gradation voltages to the data driving circuit 620 without loading the new compensating gradation voltages and the inspecting signal to the look-up table.

Subsequently, once the data driving circuit 620 receives the compensating gradation voltages, the data driving circuit 620 provides the compensating gradation voltages to the data lines 602 of the LCD panel 640 for driving the LCD panel 640.

FIG. 3 is a diagram of voltage waves including compensating gradation voltages generated by the timing control circuit 630 according to the inspecting signals. V₀ through Vₓ (where x is equal to a gradation of the active matrix LCD 600) represent a plurality of gradation voltages. +V_{(x-z)} and −V_{(x-z)} represent a pair 801 of normal gradation voltages provided to the data lines 602 in two adjacent time frames. +V_{(x-z+y)} and −V_{(x-z-y)} (where y<(x−z), and is a natural number) represent a first pair 802 of compensating gradation voltages provided to the data lines 602 in two adjacent frames according to a first inspecting signal. +V_{(x-z-y)} and −V_{(x-z+y)} represent a second pair 803 of compensating gradation voltages provided to the data lines 602 in two adjacent frames according to a second inspecting signal. The first pair 802 of the compensating gradation voltages +V_{(x-z+y)} and −V_{(x-z-y)} are obtained by adding a corresponding pair 801 of normal gradation voltages +V_{(x-z)} and −V_{(x-z)} gradations respectively. Thus an absolute value of the positive compensating gradation voltage +V_{(x-z+y)} is larger than that of the negative compensating gradation voltage +V_{(x-z-y)}. The second pair 803 of the compensating gradation voltages +V_{(x-z-y)} and −V_{(x-z+y)} are obtained by reducing the corresponding pair 801 of normal gradation voltages +V_{(x-z)} and −V_{(x-z)} gradations respectively. Thus an absolute value of the positive compensating gradation voltage +V_{(x-z-y)} is smaller than that of the negative compensating gradation voltage −V_{(x-z+y)}.

In summary, the active matrix LCD 600 includes the optical sensor 690, which generates the inspecting signals according to the flickering intensity of the display screen of the LCD panel 640. The timing control circuit 630 generates and/or accesses a plurality of compensating gradation voltages according to the inspecting signals, and sends the compensating gradation voltages to the data driving circuit 620. The compensating gradation voltages are provided from the data driving circuit 620 to the data lines 602 to suppress or even eliminate flicker of the display screen of the LCD panel 640. Thus the active matrix LCD 600 does not need to have a common voltage thereof adjusted in order to suppress or eliminate flicker of the LCD panel 640.

In an alternative embodiment, a plurality of optical sensors 690 can be positioned at selected different locations between the first substrate and the second substrate of the LCD panel 640.

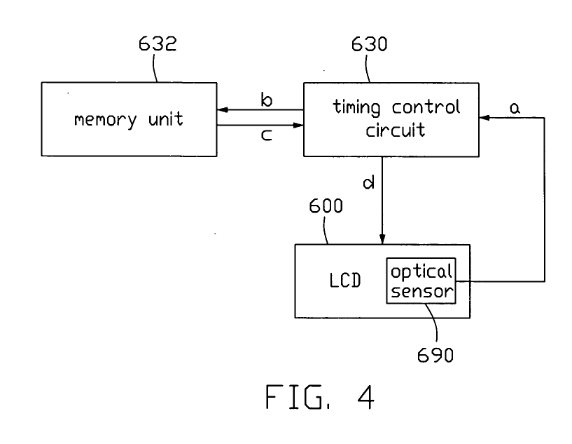

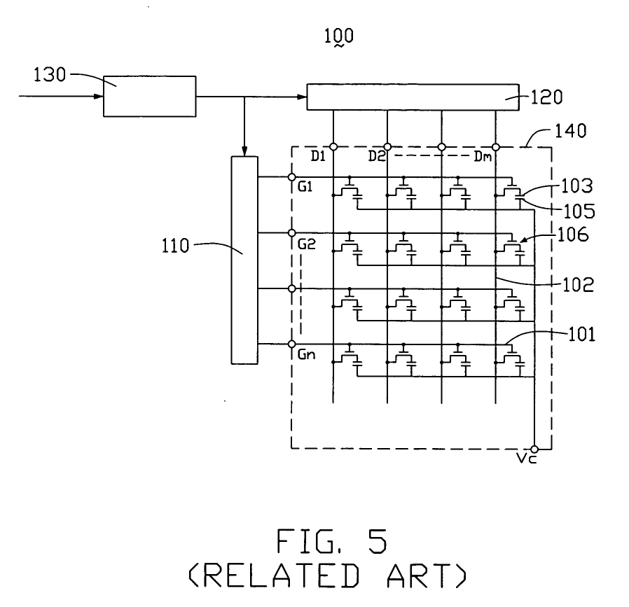

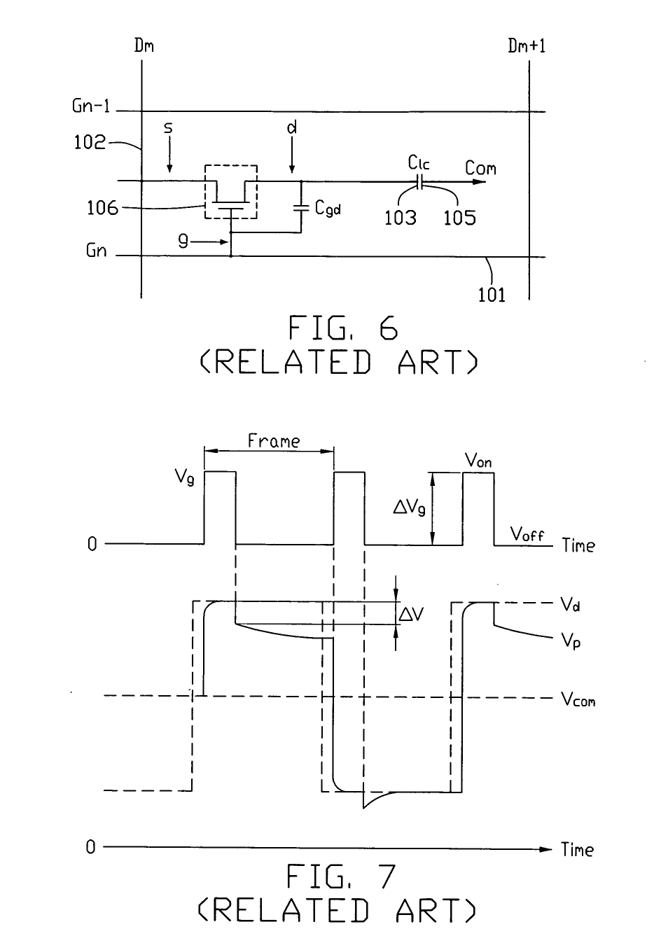

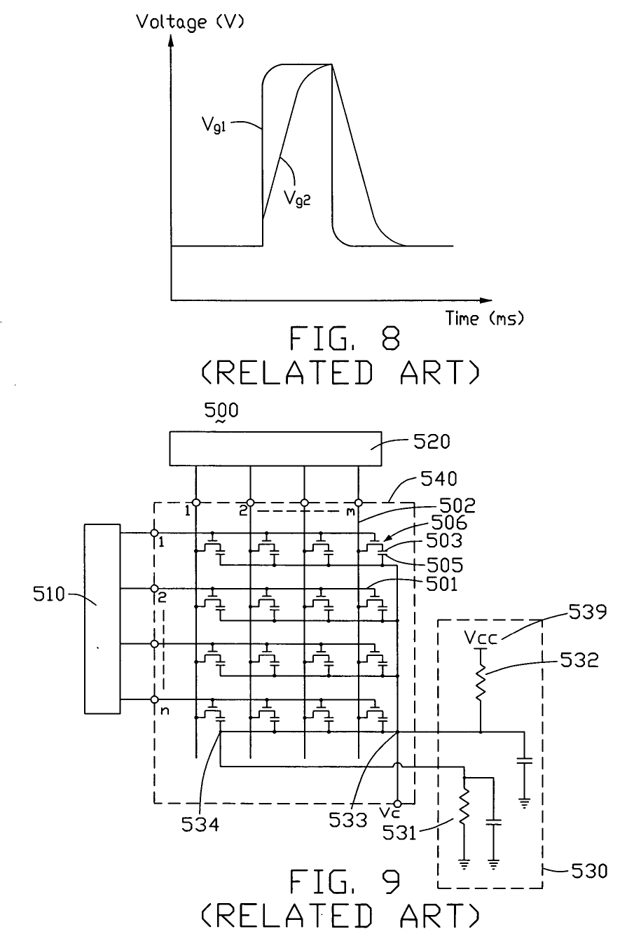

FIG. 4 is a block diagram of certain parts of the active matrix LCD 600, schematically showing steps in an exemplary driving method of the active matrix LCD 600. The exemplary method includes the following steps:

a. inspecting flicker of the display screen of the active matrix LCD panel 600, generating a plurality of inspecting signals according to a flickering intensity of the display screen, and providing the inspecting signals to the timing control circuit 630, by the optical sensor 690;

b. generating a plurality of compensating gradation voltages 802, 803 according to the inspecting signals, the compensating gradation voltages 802, 803 being configured to suppress or eliminate the flicker of the display screen, and loading the compensating gradation voltages 802, 803 into the memory unit 632, by the timing control circuit 630;

c. retrieving the compensating gradation voltages from the memory unit 632, and providing the compensating gradation voltages 802, 803 to the data driving circuit 620, by the timing control circuit 630; and

d. driving the data lines 602 with the compensating gradation voltages 802, 803, by the data driving circuit 620.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A driving circuit of an active matrix liquid crystal display (LCD) that comprises an LCD panel, the driving circuit comprising:
a plurality of gate lines that are parallel to each other and that each extend along a first direction;
a plurality of data lines that are parallel to each other and that each extend along a second direction substantially orthogonal to the first direction;
a gate driving circuit connected to the gate lines;
a data driving circuit connected to the data lines;
a timing control circuit configured for driving the data driving circuit and the gate driving circuit; and
an optical sensor connected to the timing control circuit;
wherein the optical sensor is configured for generating a plurality of inspecting signals according to a flickering intensity of the LCD panel and providing the inspecting signals to the timing control circuit, and the timing control circuit is configured for preparing a plurality of compensating gradation voltages according to the inspecting signals and providing the compensating gradation voltages to the data driving circuit.

2. The driving circuit as claimed in claim 1, wherein the timing control circuit is configured for generating a plurality of compensating gradation voltages according to the inspecting signals in order to provide the generated compensating gradation voltages to the data driving circuit.

3. The driving circuit as claimed in claim 1, wherein the timing control circuit comprises a memory unit, the memory unit stores information on relationships between different inspecting signals and corresponding pairs of compensating gradation voltages that suppress or eliminate the flicker of the LCD panel, and the timing control circuit is configured for accessing compensating gradation voltages from the memory unit in order to provide the accessed compensating gradation voltages to the data driving circuit.

4. The driving circuit as claimed in claim 1, wherein each of pairs of the compensating gradation voltages corresponding to a respective inspecting signal comprises a positive compensating gradation voltage and a negative compensating gradation voltage.

5. The driving circuit as claimed in claim 4, wherein an absolute value of the positive compensating gradation voltage is larger than that of the negative compensating gradation voltage.

6. The driving circuit as claimed in claim 4, wherein an absolute value of the negative compensating gradation voltage is larger than that of the positive compensating gradation voltage.

7. An active matrix liquid crystal display (LCD), comprising:
an LCD panel comprising two substrates facing each other, and a liquid crystal layer sandwiched between the substrates, one of the substrates comprising:
a plurality of gate lines that are parallel to each other and that each extend along a first direction; and
a plurality of data lines that are parallel to each other and that each extend along a second direction substantially orthogonal to the first direction;
a gate driving circuit connected to the gate lines;
a data driving circuit connected to the data lines;
a timing control circuit configured for driving the data driving circuit and the gate driving circuit; and
an optical sensor connected to the timing control circuit;
wherein the optical sensor is configured for generating a plurality of inspecting signals according to a flickering intensity of the LCD panel and providing the inspecting signals to the timing control circuit, and the timing control circuit is configured for preparing a plurality of compensating gradation voltages according to the inspecting signals and providing the compensating gradation voltages to the data driving circuit.

8. The active matrix LCD as claimed in claim 7, wherein the optical sensor is positioned between the two substrates.

9. The active matrix LCD as claimed in claim 7, further comprising a conducting line formed at one of the substrates, wherein the conducting line is used to transmit the inspecting signals from the optical sensor to the timing control circuit.

10. The active matrix LCD as claimed in claim 7, wherein the timing control circuit is configured for generating a plurality of compensating gradation voltages according to the inspecting signals in order to provide the generated compensating gradation voltages to the data driving circuit.

11. The active matrix LCD as claimed in claim 7, wherein the timing control circuit comprises a memory unit, the memory unit stores information on relationships between different inspecting signals and corresponding pairs of compensating gradation voltages that suppress or eliminate the flicker of the LCD panel, and the timing control circuit is configured for accessing compensating gradation voltages from the memory unit in order to provide the accessed compensating gradation voltages to the data driving circuit.

12. The active matrix LCD as claimed in claim 7, wherein each of pairs of the compensating gradation voltages corresponding to a respective inspecting signal comprises a positive compensating gradation voltage and a negative compensating gradation voltage.

13. The active matrix LCD as claimed in claim 12, wherein an absolute value of the positive compensating gradation voltage is larger than that of the negative compensating gradation voltage.

14. The active matrix LCD as claimed in claim 12, wherein an absolute value of the negative compensating gradation voltage is larger than that of the positive compensating gradation voltage.

15. A driving method for an active matrix liquid crystal display (LCD), the active matrix LCD comprising an LCD panel, an optical sensor, a timing control circuit, a data driving circuit, and a plurality of data lines, the method comprising:
inspecting flicker of the LCD panel, and generating a plurality of inspecting signals according to a flickering intensity of the active matrix LCD panel, by the optical sensor;
providing the inspecting signals to the timing control circuit;
preparing a plurality of compensating gradation voltages according to the inspecting signals, by the timing control circuit;
providing the compensating gradation voltages to the data driving circuit, by the timing control circuit; and
driving the data lines with the compensating gradation voltages, by the data driving circuit.

16. The driving method as claimed in claim 15, wherein the preparing of the plurality of compensating gradation voltages comprises generating the compensating gradation voltages.

17. The driving method as claimed in claim 16, further comprising loading the generated compensating gradation voltages and corresponding inspecting signals to a memory unit of the timing control circuit.

18. The driving method as claimed in claim 15, wherein the preparing of the plurality of compensating gradation voltages comprises obtaining the compensating gradation voltages from a memory unit of the timing control circuit.

19. The driving method as claimed in claim 15, wherein each of pairs of the plurality of compensating voltages comprises a positive compensating gradation voltage and a negative compensating gradation voltage.

20. The driving method as claimed in claim 19, wherein an absolute value of the positive compensating gradation voltage is larger than or less than that of the negative compensating gradation voltage.
